(19) United States
(12) Patent Application Publication
(10) Pub. No.: US 2026/0032389 A1
(43) Pub. Date: Jan. 29, 2026

(54) Conductive diaphragm and speaker using same

(71) Applicant: AAC Microtech (Changzhou) Co., Ltd., Changzhou City (CN)

(72) Inventors: Chao Zhang, Changzhou (CN); Yingying Wu, Changzhou (CN)

(21) Appl. No.: 19/007,593

(22) Filed: Jan. 2, 2025

Related U.S. Application Data
(63) Continuation of application No. PCT/CN2024/107275, filed on Jul. 24, 2024.

(51) Int. Cl. H04R 7/10; H04R 9/02; H04R 9/06; H04R 31/00

(52) U.S. Cl. CPC H04R 7/10; H04R 9/06; H04R 31/003; H04R 9/025; H04R 2231/001; H04R 2307/023; H04R 2307/025; H04R 2307/027

(57) ABSTRACT

The present disclosure provides a conductive diaphragm and a speaker using same. The conductive diaphragm includes a main portion made of polymer material and a conductive portion located on the main portion. The conductive portion includes a substrate with a film layer and conductive material dispersed in the substrate, the film layer is solidified from at least one material of thermoplastic elastomer, phenyl silicone, isoprene rubber, or fluoroelastomer. Compared with the related technologies, the conductive diaphragm disclosed by the present disclosure has excellent atigue-resistant property and could maintain good adhesive strength and toughness.

### FIELD OF THE INVENTION

The invention relates to the technical field of electro-acoustic transducers, in particular to a conductive diaphragm and a speaker using same.

### BACKGROUND

At present, a conductive portion in a conductive diaphragm used in a speaker mainly consists of polymer matrix and conductive filler. In the preparation of conductive diaphragm, in order to reduce the resistance of the conductive portion to enhance the conductive ability of the conductive diaphragm, it is usually necessary to increase the amount of conductive filler in the polymer matrix, but the amount of conductive filler filling in the polymer matrix is too large to affect the toughness of the conductive portion, thus reducing the toughness of the conductive diaphragm, which cannot meet the needs of conductive diaphragm.

Therefore, there is a need for a new technical solution to meet the needs of the conductive diaphragm in terms of toughness.

### SUMMARY

The present disclosure is to provide a conductive diaphragm with excellent atigue-resistant property and good adhesive strength and toughness.

For achieving the object mentioned above, the disclosure provides a conductive diaphragm including a main portion made of polymer material and a conductive portion located on the main portion. The conductive portion includes a substrate with a film layer and conductive material dispersed in the substrate, the film layer is solidified from at least one material of thermoplastic elastomer, phenyl silicone, isoprene rubber, or fluoroelastomer.

Further, the content of the conductive material in the conductive portion is 15 wt %˜95 wt % in terms of mass percentage, the conductive material includes at least one of metal powder, carbon-based particle, or electrically conductive composite powder.

Further, the metal powder includes at least one of silver powder, gold powder, copper powder, aluminum powder, or nickel powder.

Further, the material of the carbon-based particle is a selection from at least one of carbon black, graphene, or carbon nanotubes.

Further, the material of electrically conductive composite powder is at least selected from one combination of silver and gold, silver and copper, silver and nickel, silver and aluminum, silver and vanadium, silver and indium, or silver and palladium.

Further, the conductive material includes at least one of spherical particle, sheet particle, rod particle or irregular polygonal particle.

Further, the main portion is made of at least one of polyetheretherketone, thermoplastic polyester elastomer, thermoplastic polyurethane elastomer, silicone rubber, ethylene-acrylate rubber, acrylate rubber, or hydrogenated nitrile rubber.

Further, one part of the conductive portion is embedded in the main portion, and the other part of the conductive portion is exposed to be electrically connected to an external circuit.

Further, the conductive portion is coated or bonded to one side surface of the main portion; or, the main portion is injection molded integrally with the conductive portion.

A sound producing apparatus includes a vibration system including a conductive diaphragm as described above, and a magnetic circuit system driving the vibration system to vibrate and sound.

### BRIEF DESCRIPTION OF THE DRAWINGS

In order to explain the technical solutions of the embodiments of the present disclosure more clearly, accompanying drawings used to describe the embodiments are briefly introduced below. It is evident that the drawings in the following description are only concerned with some embodiments of the present disclosure. For those skilled in the art, in a case where no inventive effort is made, other drawings may be obtained based on these drawings.

FIG. 1 is an isometric view of a conductive diaphragm with a conductive portion embedded in a main portion to an embodiment of the present disclosure;

FIG. 2 is an isometric view of a conductive diaphragm with a conductive portion provided on one side of a main portion to the other embodiment of the present disclosure.

### DESCRIPTION OF THE EMBODIMENTS

The present disclosure will be further illustrated with reference to the accompanying drawings. It shall be noted that the elements of similar structures or functions are represented by like reference numerals throughout the figures. The embodiments described herein are not intended as an exhaustive illustration or description of various other embodiments or as a limitation on the scope of the claims or the scope of some other embodiments that are apparent to one of ordinary skills in the art in view of the embodiments described in the application. In addition, an illustrated embodiment need not have all the aspects or advantages shown.

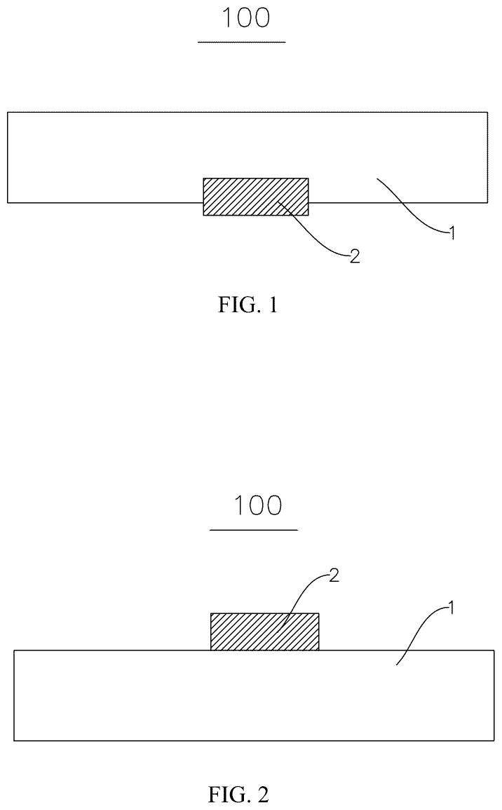

As shown in the FIGS. 1-2, the present invention discloses a conductive diaphragm 100 including a main portion 1 and a conductive portion 2 located on the main portion 1, the conductive portion 2 includes a substrate and conductive material dispersed in the substrate, the substrate includes a film layer solidified from at least one material of thermoplastic elastomer, phenyl silicone, isoprene rubber, or fluoroelastomer, so as to enable the conductive portion 2 to have excellent elasticity, adhesive strength, mechanical property, and fatigue-resistant property, and to maintain good adhesive strength and toughness even when the conductive material has a high filler quantity, in addition, the conductive portion 2 is highly adaptable to different kinds of materials of the main body portion 1, with high adhesion and good toughness.

Further, the content of the conductive material in the conductive portion 2 is 15 wt %˜95 wt % in terms of mass percentage, the conductive material includes at least one of metal powder, carbon-based particle, or electrically conductive composite powder.

The metal powder includes at least one of silver powder, gold powder, copper powder, aluminum powder, or nickel powder. The material of the carbon-based particle is a selection from at least one of carbon black, graphene, or carbon nanotubes. The material of electrically conductive composite powder is at least selected from one combination of silver and gold, silver and copper, silver and nickel, silver and aluminum, silver and vanadium, silver and indium, or silver and palladium.

Optionally, the conductive material includes at least one of spherical particle, sheet particle, rod particle or irregular polygonal particle.

The shape of the conductive material has a high correlation with the preparation process, and the shape of the conductive material prepared by different processes is different, but its conductive properties are basically the same. When the contact resistance of the conductive material is reduced, a combination of the conductive materials with different shapes and sizes in a certain ratio should be used to achieve a target resistance value. The size of the conductive material is the maximum length of the conductive material, and the size of the conductive material is related to the elongation at break of the substrate of the conductive portion 2. The larger the size, the lower the elongation at break of the substrate of the electrically conductive portion 2 prepared thereof, and at the same time, and the higher the degree of roughness of the surface thereof, so that the appropriate size is selected according to the actual need. Preferably, the size of the conductive material does not exceed 40 μm.

In addition, the main portion 1 is made of at least one of polyetheretherketone, thermoplastic polyester elastomer, thermoplastic polyurethane elastomer, silicone rubber, ethylene-acrylate rubber, acrylate rubber, or hydrogenated nitrile rubber.

Further, as shown in the FIG. 1, one part of the conductive portion 2 is embedded in the main portion, and the other part of the conductive portion 2 is exposed to be electrically connected to a voice coil of a sound producing apparatus and an external circuit. Therefore, the conductive diaphragm 100 could effectively ensure the assembly stability of the conductive portion 2 on the main body portion 1. In addition, as one part of the conductive portion 2 is embedded in the main portion 1, the thickness of the conductive diaphragm 100 could be reduced to a certain extent and the design space of the product could be increased, the vibration consistency between the conductive portion 2 and the main portion 1 could be enhanced, the sound-emitting effect of the conductive diaphragm 100, the other part of the conductive portion 2 is exposed to facilitate the operation of the circuit connection.

In the other embodiment, as shown in the FIG. 2, the conductive portion 2 is coated or bonded to one side surface of the main portion 1; or, the main portion 1 is injection molded integrally with the conductive portion 2.

That is, when the conductive portion 2 is disposed on the surface of the main portion 1, the conductive portion 2 and the main portion 1 may be combined by a plurality of ways, for example, the conductive portion 2 is disposed on the surface of the main body portion 1 by means of coating, the conductive portion 2 is disposed on the surface of the main body portion 1 by means of adhesion or the conductive portion 2 is disposed on the surface of the main body portion 1 by means of one-piece injection molding.

The present invention further discloses a sound producing apparatus including a vibration system and a magnetic circuit system driving the vibration system to vibrate and sound. The vibration system includes a conductive diaphragm 100 as described above.

Compared with the related art, the present invention includes the conductive diaphragm with the substrate, the substrate includes a film layer solidified from at least one material of thermoplastic elastomer, phenyl silicone, isoprene rubber, or fluoroelastomer, so as to enable the conductive portion 2 to have excellent elasticity, adhesive strength, mechanical property, and fatigue-resistant property, and to maintain good adhesive strength and toughness even when the conductive material has a high filler quantity, in addition, the conductive portion 2 is highly adaptable to different kinds of materials of the main body portion 1, with high adhesion and good toughness.

It should be appreciated by those skilled in the art that various modifications are possible without departing from the spirit or scope of the present invention. The embodiments illustrated above should not be interpreted as limits to the present invention, and the scope of the invention is to be determined by reference to the claims that follow.

What is claimed is:

1. A conductive diaphragm comprising:
a main portion made of polymer material; and
a conductive portion located on the main portion, comprising a substrate with a film layer and conductive material dispersed in the substrate, the film layer solidified from at least one material of thermoplastic elastomer, phenyl silicone, isoprene rubber, or fluoroelastomer.

2. The conductive diaphragm as described in claim 1, wherein the content of the conductive material in the conductive portion is 15 wt %˜95 wt % in terms of mass percentage, the conductive material comprises at least one of metal powder, carbon-based particle, or electrically conductive composite powder.

3. The conductive diaphragm as described in claim 2, wherein the metal powder comprises at least one of silver powder, gold powder, copper powder, aluminum powder, or nickel powder.

4. The conductive diaphragm as described in claim 2, wherein the material of the carbon-based particle is a selection from at least one of carbon black, graphene, or carbon nanotubes.

5. The conductive diaphragm as described in claim 2, wherein the material of electrically conductive composite powder is at least selected from one combination of silver and gold, silver and copper, silver and nickel, silver and aluminum, silver and vanadium, silver and indium, or silver and palladium.

6. The conductive diaphragm as described in claim 1, wherein the conductive material comprises at least one of spherical particle, sheet particle, rod particle or irregular polygonal particle.

7. The conductive diaphragm as described in claim 1, wherein the main portion is made of at least one of polyetheretherketone, thermoplastic polyester elastomer, thermoplastic polyurethane elastomer, silicone rubber, ethylene-acrylate rubber, acrylate rubber, or hydrogenated nitrile rubber.

8. The conductive diaphragm as described in claim 1, wherein one part of the conductive portion is embedded in the main portion, and the other part of the conductive portion is exposed to be electrically connected to an external circuit.

9. The conductive diaphragm as described in claim 1, wherein the conductive portion is coated or bonded to one side surface of the main portion; or, the main portion is injection molded integrally with the conductive portion.

10. A sound producing apparatus comprising:
a vibration system comprising a conductive diaphragm as described in claim 1; and
a magnetic circuit system driving the vibration system to vibrate and sound.
